(19) United States
(12) Patent Application Publication
(10) Pub. No.: US 2013/0250194 A1
(43) Pub. Date: Sep. 26, 2013

(54) AUTOSTEREOSCOPIC DISPLAY APPARATUS

(71) Applicants: INNOCOM TECHNOLOGY(SHENZHEN) CO., LTD, Shenzhen City (CN); CHIMEI INNOLUX CORPORATION, Miao-Li County (TW)

(72) Inventors: Ming-Yao TSAI, Miao-Li County (TW); Satoru TAKAHASHI, Miao-Li County (TT); Chen-You CHEN, Miao-Li County (TW); Jian-Min LEU, Miao-Li County (TW); Toshihiko ARAKI, Miao-Li County (TW); Yung-Hsin LU, Miao-Li County (TW); Shao-Wu HSU, Miao-Li County (TW)

(73) Assignees: CHIMEI INNOLUX CORPORATION, Miao-Li County (TW); INNOCOM TECHNOLOGY(SHENZHEN) CO., LTD., Shenzhen City (CN)

(21) Appl. No.: 13/721,878

(22) Filed: Dec. 20, 2012

(30) Foreign Application Priority Data
Mar. 21, 2012 (TW) 101109605

(51) Int. Cl. G02F 1/13

(52) U.S. Cl. CPC G02F 1/1313
USPC 349/15

(57) ABSTRACT

An autostereoscopic display apparatus is provided. The autostereoscopic display apparatus includes a liquid-crystal panel and a barrier cell. The barrier cell includes a first substrate, a second substrate, and a liquid-crystal layer. The first substrate includes a first electrode. The second substrate includes a second electrode and a third electrode, wherein the second and third electrodes are separated from each other. The liquid-crystal layer is disposed between the first and second substrates. A black region between the first and third electrodes is formed when a first voltage is applied to the first and second electrodes and a second voltage is applied to the third electrode.

### CROSS REFERENCE TO RELATED APPLICATIONS

This Application claims priority of Taiwan Patent Application No. 101109605, filed on Mar. 21, 2012, the entirety of which is incorporated by reference herein.

### BACKGROUND OF THE INVENTION

1. Field of the Invention

The invention relates to an autostereoscopic display apparatus, and more particularly to a parallax barrier cell of an autostereoscopic display apparatus.

2. Description of the Related Art

A three-dimensional (3D) image is formed according to the principle of autostereoscopic vision by the eyes of a human being. Binocular parallax, which is generated by the distance of about 65 mm between a human's left and right eyes, can be considered the most important factor inducing the perception of depth of field.

In recent years, 3D video content, in which video can be viewed in a three-dimensional manner, has attracted much development attention. There are two types of systems for viewing 3D video: a glasses system using polarizing filter glasses (passive polarized glasses) or shutter glasses; and a naked-eye system that does not require glasses, instead using other methods such as a lenticular system or a parallax barrier system.

In a two-dimensional/three-dimensional switchable display system that uses the parallax barrier method, Twisted Nematic (TN) liquid crystals are usually used to perform barrier switching. However, a transitive region between a black region and a white region is generated when the TN liquid crystals of a conventional barrier cell are driven. Furthermore, a tangle phenomenon caused by the twists of TN liquid crystals, can easily generate a larger value in brightness at two sides of the transitive region, thereby a discontinuous brightness phenomenon is generated.

Therefore, an autostereoscopic display apparatus that has a smaller transitive region and is able to avoid a discontinuous brightness phenomenon is desired.

### BRIEF SUMMARY OF THE INVENTION

Autostereoscopic display apparatus are provided. An embodiment of an autostereoscopic display apparatus is provided. The autostereoscopic display apparatus comprises a liquid-crystal panel and a barrier cell. The barrier cell comprises: a first substrate, comprising a first electrode; a second substrate, comprising a second electrode and a third electrode, wherein the second and third electrodes are separated from each other; and a liquid-crystal layer disposed between the first and second substrates. A first black region corresponding to the overlap of the first and third electrodes is formed when a first voltage is applied to the first and second electrodes and a second voltage is applied to the third electrode.

Furthermore, another embodiment of an autostereoscopic display apparatus is provided. The autostereoscopic display apparatus comprises a liquid-crystal panel and a barrier cell. The barrier cell comprises: a first substrate, comprising a first electrode; a second substrate, comprising a second electrode and a plurality of third electrodes, wherein the second electrode and the third electrodes are separated from each other, and each of the third electrodes is floating and is surrounded by the second electrode; and a liquid-crystal layer disposed between the first and second substrates. A black region corresponding to the overlap of the first and second electrodes is formed when a first voltage is applied to the first electrode and a second voltage is applied to the second electrode.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a two-dimensional/three-dimensional switchable autostereoscopic display apparatus according to an embodiment of the invention;

FIG. 2A shows a barrier cell according to an embodiment of the invention;

FIG. 2B shows a circuit schematic diagram illustrating a section line A-A′ of the barrier cell of FIG. 2A;

FIG. 3 shows a schematic diagram illustrating equal potential lines and liquid-crystal distribution of the circuit R1 in the barrier cell of FIG. 2B;

FIG. 4A shows a barrier cell according to another embodiment of the invention;

FIG. 4B shows a circuit schematic diagram illustrating a section line B-B′ of the barrier cell of FIG. 4A;

FIG. 5 shows a simple circuit diagram of the electrodes of FIG. 4B;

FIG. 6A shows a barrier cell according to another embodiment of the invention;

FIG. 6B shows a circuit schematic diagram illustrating a section line C-C′ of the barrier cell of FIG. 6A;

FIG. 6C shows a circuit schematic diagram illustrating a section line D-D′ of the barrier cell of FIG. 6A.

FIG. 7A shows a brightness schematic diagram of the barrier cell of FIG. 6A;

FIG. 7B shows another brightness schematic diagram of the barrier cell of FIG. 6A; and

FIG. 8 shows a schematic illustrating an arrangement of a color filter and a barrier cell of a single pixel of an autostereoscopic display apparatus according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

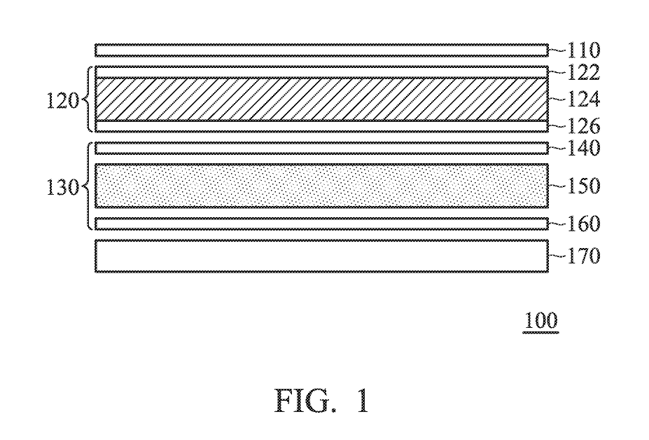

FIG. 1 shows a two-dimensional/three-dimensional switchable autostereoscopic display apparatus 100 according to an embodiment of the invention. The autostereoscopic display apparatus 100 comprises a polarizer 110, a barrier cell 120, a liquid-crystal panel 130, and a back light 170. The barrier cell 120 comprises an upper substrate 122, a liquid-crystal layer 124 and a lower substrate 126, wherein the liquid-crystal layer 124 comprises a plurality of Twisted Nematic (TN) liquid crystals. The liquid-crystal panel 130 comprises a polarizer 140, a liquid-crystal array 150, and a polarizer 160. The liquid-crystal array 150 comprises a Thin Film Transistor (TFT) substrate (not shown), a color filter substrate (not shown) and a liquid-crystal layer (not shown) disposed between the TFT substrate and the color filter substrate, wherein the color substrate may be a glass substrate or a polymer substrate, and the liquid-crystal layer may be formed by TN liquid crystals, Vertical Alignment (VA) liquid crystals or In place Switch (IPS) liquid crystals. In the embodiment, the upper substrate 122 and the lower substrate 126 are the glass substrates. Furthermore, the upper substrate 122 and the lower substrate 126 may be the polymer substrates. Moreover, the polarizer 110 is an upper polarizer, the polarizer 140 is a middle polarizer and the polarizer 150 is a lower polarizer. In the three-dimensional mode of the autostereoscopic display apparatus 100, the switching state of the barrier cell 120 is controlled by applying voltage to the barrier cell 120, so as to selectively block the light from the back light 170 and limit the emergence direction of the light. Thus, the left and right eyes respectively receive the left eye image and the right eye image for generating stereo vision. In a two-dimensional mode of the autostereoscopic display apparatus 100, no voltage is applied to the barrier cell 120, so as to hold a normally white state for the TN liquid crystals. Therefore, an image of the liquid-crystal panel 130 is completely passed, so as to display a two-dimensional image. Furthermore, a wide-view file is further disposed on the polarizer 110, 140 or 160, so that ISO CR range is spread to reach a contrast balance.

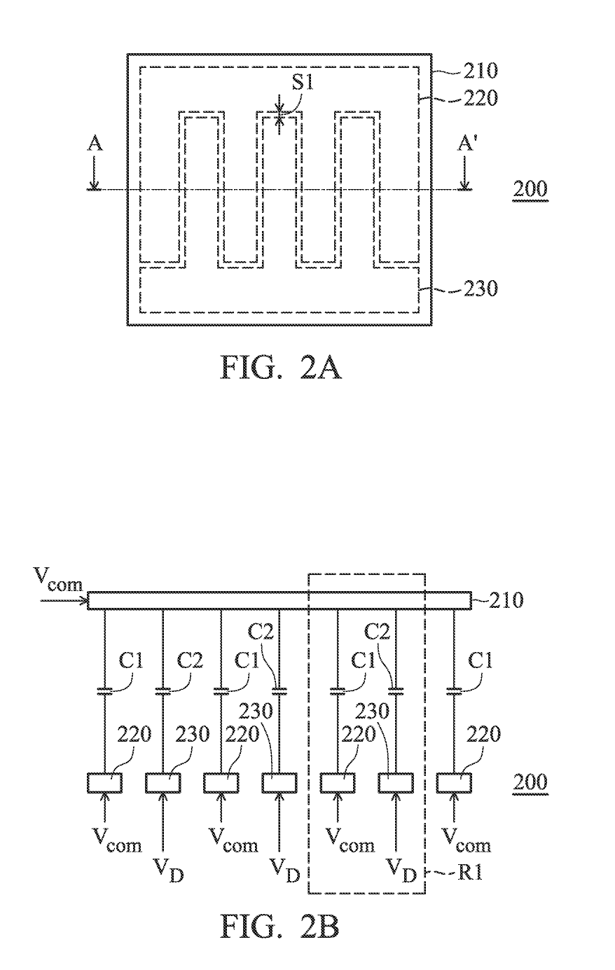

FIG. 2A shows a barrier cell 200 according to an embodiment of the invention. The barrier cell 200 comprises three electrodes 210, 220 and 230, wherein the electrodes 210, 220 and 230 are formed by transparent electrodes, e.g. Indium Tin Oxide (ITO). In the embodiment, the electrode 210 is disposed on an upper substrate of the barrier cell 200 (e.g. 122 of FIG. 1), and the electrodes 220 and 230 are disposed on a lower substrate of the barrier cell 200 (e.g. 126 of FIG. 1). It should be noted that the electrodes 220 and 230 are disposed on a common plane and separated from each other. In addition, finger parts of the electrodes 220 and 230 are mutually interlaced and separated by a slit S1. Furthermore, the electrodes 220 and 230 and the slit S1 are entirely overlaid by the electrode 210. In the three-dimensional mode of the embodiment, the barrier cell 200 is turned on when a common voltage V_{COM} is applied to the electrodes 210 and 220 and a driving voltage V_{D} is applied to the electrode 230, wherein a difference between the common voltage V_{COM} and the driving voltage V_{D} is larger than a threshold voltage and is also larger than 90% level of grey scale. Thus, the TN liquid crystals between the electrodes 210 and 230 form a black region Z_{B} (the black region Z_{B} corresponds to the overlap of electrode 210 and 230), and the TN liquid crystals between the electrodes 210 and 220 form a white region Z_{W} (the white region Z_{W} corresponds to the overlap of electrode 210 and 220). The common voltage may be a DC grounding voltage (e.g. 0V), or a DC/AC low voltage (e.g. DC 5V, AC 2.5V). The black region Z_{B} and the white region Z_{W} are the optical results when light pass through polarizer and liquid crystal layer. Furthermore, the barrier cell 200 holds the normally white state of the TN liquid crystals as a two-dimensional mode when the driving voltage V_{D} is applied to the electrodes 220 and 230 simultaneously. In one embodiment, the electrode 210 is disposed on the lower substrate of the barrier cell 200, and the electrodes 220 and 230 are disposed on the upper substrate of the barrier cell 200.

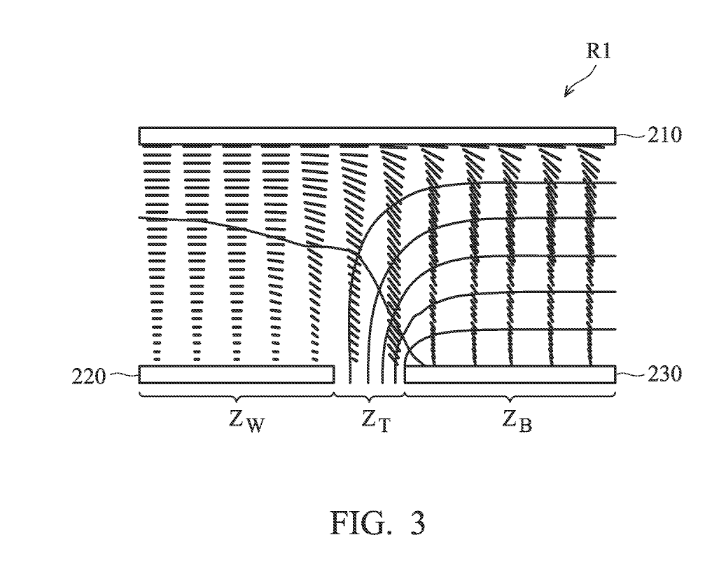

FIG. 2B shows a circuit schematic diagram illustrating a section line A-A′ of the barrier cell 200 of FIG. 2A. In FIG. 2B, the common voltage V_{com} is applied to the electrodes 210 and 220 and the driving voltage V_{D} is applied to the electrode 230, such that the barrier cell 200 is switched to three-dimensional mode. An equivalent capacitor of the liquid-crystal layer between the electrodes 210 and 220 is C1, and an equivalent capacitor of the liquid-crystal layer between the electrodes 210 and 230 is C2, wherein the voltage difference of the equivalent capacitor C1 is 0, thereby the capacitance of the equivalent capacitor C1 is 0. Compared with a conventional barrier cell, the equivalent capacitor C1 disposed on the barrier cell 200 can minimize the transitive region Z_{T} between the black region Z_{B} and the white region Z_{W} and improve image X-talk. In the embodiment, the transitive region Z_{T} is defined as a region between the 10% level and the 90% level on the grey scale. FIG. 3 shows a schematic diagram illustrating equal potential lines and liquid-crystal distribution of the circuit R1 in the barrier cell 200 of FIG. 2B. Referring to FIG. 2B and FIG. 3 together, in an electric field distribution diagram, the equivalent capacitor C1 makes the equal potential lines concentrate in the white region Z_{W} and the transitive region Z_{T}. In other words, an original state that no voltage is applied is held by the liquid crystals within a region of the equivalent capacitor C1, so that the transitive region Z_{T} between the white region Z_{W} and the black region Z_{B} is narrowed. Therefore, for a conventional barrier cell without the equivalent capacitor C1, the equal potential lines and the transitive region Z_{T} will extend to the white region Z_{W}, thus the width of the transitive region Z_{T} is larger than that of the embodiment.

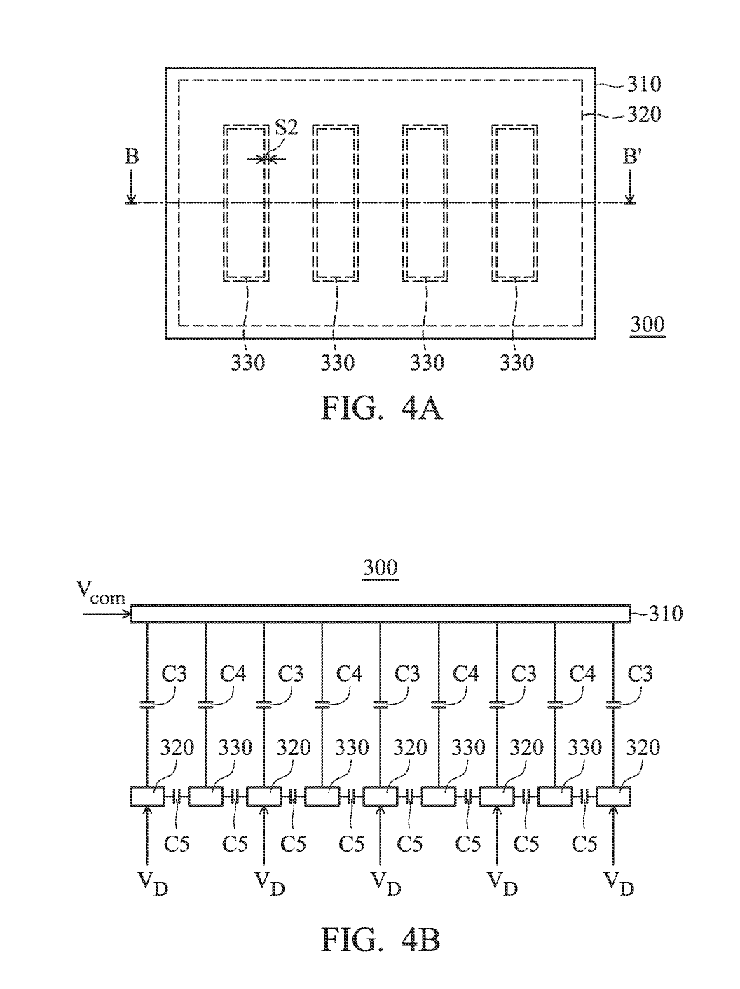

FIG. 4A shows a barrier cell 300 according to another embodiment of the invention. The barrier cell 300 comprises an electrode 310, an electrode 320 and a plurality of electrodes 330, wherein the electrodes 310, 320 and 330 are formed by transparent electrodes. The electrode 310 is disposed on an upper substrate of the barrier cell 300 (e.g. 122 of FIG. 1), and the electrodes 320 and 330 are disposed on a lower substrate of the barrier cell 300 (e.g. 126 of FIG. 1). It should be noted that the electrodes 320 and 330 are disposed on a common plane and separated from each other. In addition, each of the electrodes 330 is a bar and is surrounded by the electrode 320, wherein a slit between the electrode 320 and each electrode 330 is slit S2. Moreover, the electrodes 320 and 330 and the slit S2 are entirely overlaid by the electrode 310. It should be noted that each of the electrodes 330 is floating, i.e. not electrically connect to other conductor electrodes. In the three-dimensional mode of the embodiment, when the common voltage V_{com} is applied to the electrode 310 and the driving voltage V_{D} is applied to the electrode 320, the barrier cell 300 is turned on. Thus, TN liquid crystals between the electrodes 310 and 320 form a black region Z_{B} corresponding to the overlap of electrode 310 and 320, and the TN liquid crystals between the electrodes 310 and 330 form a white region Z_{W} corresponding to the overlap of the electrode 310 and 330. In one embodiment, the electrode 310 is disposed on the lower substrate of the barrier cell 300, and the electrodes 320 and 330 are disposed on the upper substrate of the barrier cell 300.

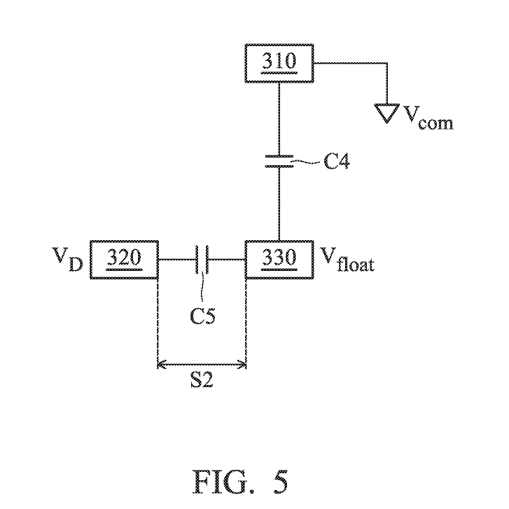

FIG. 4B shows a circuit schematic diagram illustrating a section line B-B′ of the barrier cell 300 of FIG. 4A. In FIG. 4B, the common voltage V_{com} is applied to the electrode 310 and the driving voltage V_{D} is applied to the electrode 320, such that the barrier cell 300 is switched on. An equivalent capacitor of the liquid-crystal layer between the electrodes 310 and 320 is C3, and an equivalent capacitor of the liquid-crystal layer between the electrodes 310 and 330 is C4. Furthermore, an equivalent capacitor of the liquid-crystal layer between the electrodes 320 and 330 is C5, wherein a voltage V_{float} of the electrode 330 is determined by the equivalent capacitors C4 and C5. FIG. 5 shows a simple circuit diagram of the electrodes 310, 320 and 330 of FIG. 4B in order to simplify the description. In general, the capacity of a capacitor is in direct ratio to the area A of its metal plate and the dielectric constant ε, and is in an inverse ratio of the distance d between the two metal plates, i.e.

$$C = \frac{ɛ A}{d} .$$

Therefore, the equivalent capacitor C4 is increased when the distance between the electrodes 310 and 330 is decreased. Moreover, the equivalent capacitor C4 is also increased when the area of the electrode 330 is increased. In addition, the equivalent capacitor C5 is decreased when the slit S2 between the electrodes 320 and 330 is increased. Thus, the equivalent capacitor C4 is much larger than the equivalent capacitor C5 (i.e. C4>>C5). Therefore, the equivalent capacitor C5 is about equal to a total capacitor Cₜₒₜₐₗ according to the following formula:

$$\frac{1}{{C}_{total}} = \frac{1}{C 4} + \frac{1}{C 5} ⇒ \frac{C 5}{{C}_{total}} ≅ 1 ⇒ C 5 ≅ C total .$$

Furthermore, the voltage V_{float} of the electrode 330 is about 0V according to the following formula:

$${C}_{total} = \frac{Q}{{V}_{D}} ≅ C 5 = \frac{Q}{{V}_{D} - {V}_{float}} ⇒ {V}_{float} ≅ 0 ,$$

Where Q represents the charges stored in the total capacitor Cₜₒₜₐₗ. As describe above, when the voltage V_{float} of the electrode 330 is 0V, the equivalent capacitor C4 of the barrier cell 300 can minimize a transitive region Z_{T} between the black region Z_{B} and the white region Z_{W} and improve image X-talk.

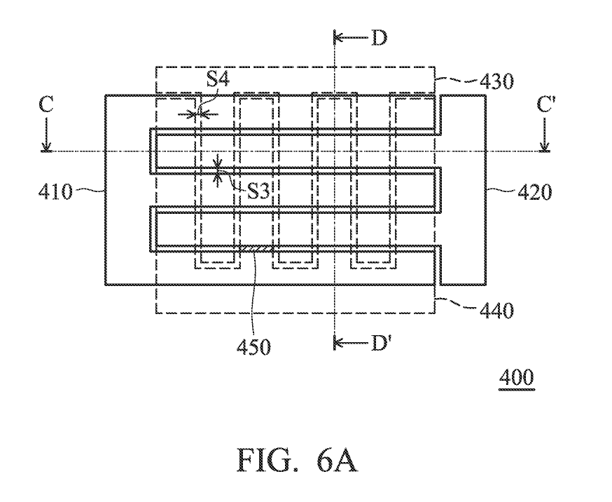

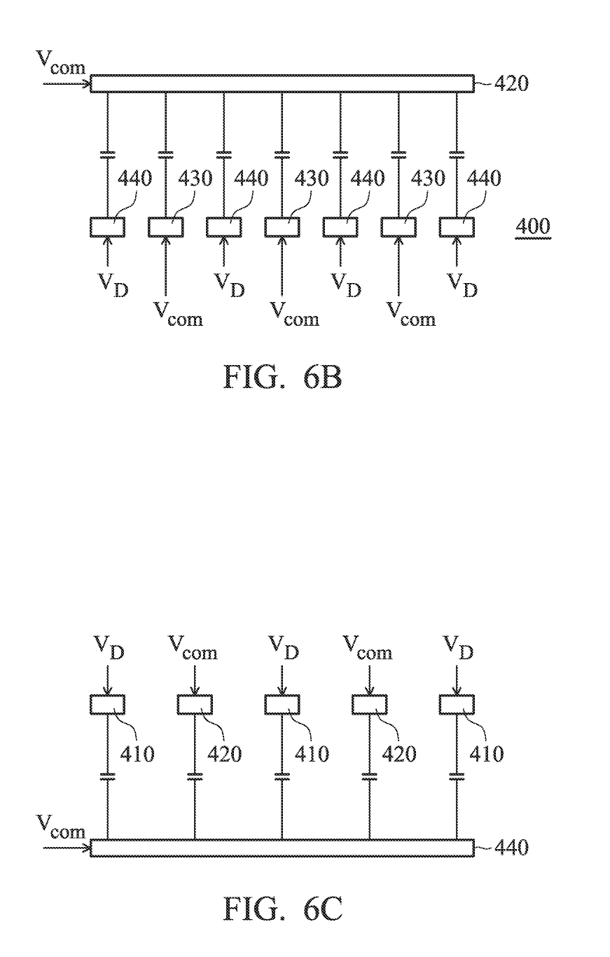

FIG. 6A shows a barrier cell 400 according to another embodiment of the invention. An autostereoscopic display apparatus equipped with the barrier cell 400 can be implemented in a portable electronic product, such as a smart phone or a tablet. The autostereoscopic display apparatus is able to provide a three-dimensional image when the portable electronic product is operating in a landscape mode or a portrait mode. The barrier cell 400 comprises the electrodes 410, 420, 430 and 440, wherein the electrodes 410, 420, 430 and 440 are formed by transparent electrodes. The electrodes 410 and 420 are disposed on an upper substrate of the barrier cell 400 (e.g. 122 of FIG. 1), and the electrodes 430 and 440 are disposed on a lower substrate of the barrier cell 400 (e.g. 126 of FIG. 1). It should be noted that the electrodes 410 and 420 are disposed on a common plane and separated from each other, and finger parts of the electrodes 410 and 420 are mutually interlaced and separated by a slit S3. In addition, the electrodes 430 and 440 are disposed on a common plane and separated from each other, and finger parts of the electrodes 430 and 440 are mutually interlaced and separated by a slit S4. According to various operation modes of the portable electronic product, the corresponding voltages are applied to the electrodes 410-440, so as to control the switching state of the barrier cell 400. For example, if the portable electronic product is operating in the three-dimensional display landscape mode, the barrier cell 400 is turned on when the common voltage V_{com} is applied to the electrodes 410, 420 and 430 and the driving voltage V_{D} is applied to the electrode 440. Thus, TN liquid crystals between the electrodes 440 and 410 and between the electrodes 440 and 420 may form the black regions Z_{B} corresponding to the overlap of the electrode 440 and 420, and the TN liquid crystals between the electrodes 430 and 410 and between the electrodes 430 and 420 may form the white regions Z_{W} corresponding to the overlap the of electrode 430 and 420. If the portable electronic product is operating in three-dimensional display portrait mode, the barrier cell 400 is turned on when the common voltage V_{com} is applied to the electrodes 420, 430 and 440 and the driving voltage is applied to the electrode 410. Thus, TN liquid crystals between the electrodes 410 and 430 and between the electrodes 410 and 440 form the black regions Z_{B} corresponding to the overlap of the electrode 410 and 440, and the TN liquid crystals between the electrodes 420 and 430 and between the electrodes 420 and 440 form the white regions Z_{W} corresponding to the overlap of the electrode 410 and 440. Furthermore, in the embodiment, the slits S3 and S4 have the same distance. In one embodiment, the electrodes 410 and 420 are disposed on the lower substrate of the barrier cell 400, and the electrodes 430 and 440 are disposed on the upper substrate of the barrier cell 400.

FIG. 6B shows a circuit schematic diagram illustrating a section line C-C′ of the barrier cell 400 of FIG. 6A. In FIG. 6B, the common voltage V_{com} is applied to the electrodes 420 and 430 and the driving voltage V_{D} is applied to the electrode 440, such that the barrier cell 400 is switched on. Similarly, a capacitor between the electrodes 420 and 430 can minimize the transitive region Z_{T} between the black region Z_{B} and the white region Z_{W} and improve image X-talk. FIG. 6C shows a circuit schematic diagram illustrating a section line D-D′ of the barrier cell 400 of FIG. 6A. In FIG. 6C, the common voltage V_{com} is applied to the electrodes 420 and 440 and the driving voltage V_{D} is applied to the electrode 410, such that the barrier cell 400 is switched on. Similarly, a capacitor between the electrodes 420 and 440 can minimize the transitive region Z_{T} between the black region Z_{B} and the white region Z_{W} and improve image X-talk.

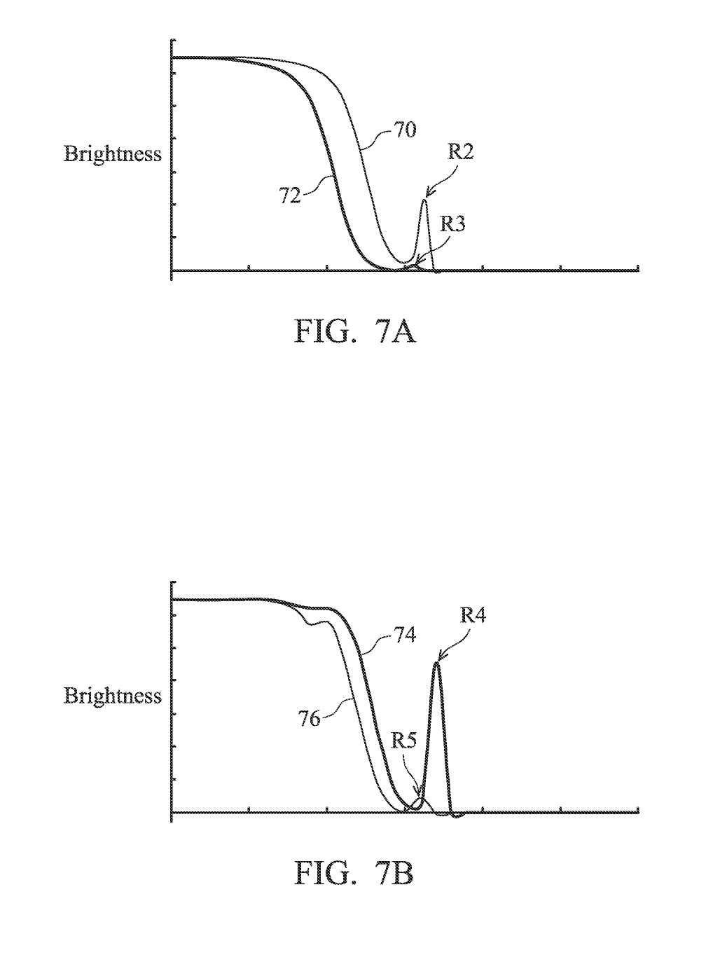

Referring back to FIG. 6A, the light leak phenomenon (as shown in label 450) caused by a larger slit can be avoided by narrowing the distances of the slits S3 and S4, for example, the slits S3 and S4 are smaller than 7 um. Thus, the discontinuous line within the black region also disappears. An overdriving voltage may be applied to the electrode except the narrower slit, i.e. the voltage levels of the common voltage V_{com} and the driving voltage V_{D} are increased, so as to avoid the light leak phenomenon. Furthermore, the overdriving manner can decrease the liquid-crystal tangle phenomenon and improve the discontinuous brightness phenomenon. FIG. 7A shows a brightness schematic diagram of the barrier cell 400 of FIG. 6A. In FIG. 7A, the liquid-crystal layer of the barrier cell 400 is formed by low driving voltage TN liquid crystals and the common voltage V_{com} is 0, wherein a curve 70 represents a brightness corresponding to the normal driving voltage (e.g. V_{D}±2.5V), and a curve 72 represents a brightness corresponding to the overdriving voltage (e.g. V_{D}±5V). Compared to the discontinuous brightness phenomenon of the curve 70 (as shown in an arrow R2), the discontinuous brightness phenomenon of the curve 72 (as shown in an arrow R3) is noticeably decreased. FIG. 7B shows another brightness schematic diagram of the barrier cell 400 of FIG. 6A. In FIG. 7B, the liquid-crystal layer of the barrier cell 400 is formed by normal TN liquid crystals and the common voltage V_{com} is 0, wherein a curve 74 represents a brightness corresponding to a normal driving voltage (e.g. V_{D}±5V), and a curve 76 represents a brightness corresponding to an overdriving voltage (e.g. V_{D}±7V). Compared to the discontinuous brightness phenomenon of the curve 74 (as shown in an arrow R4), the discontinuous brightness phenomenon of the curve 76 (as shown in an arrow R5) is noticeably decreased.

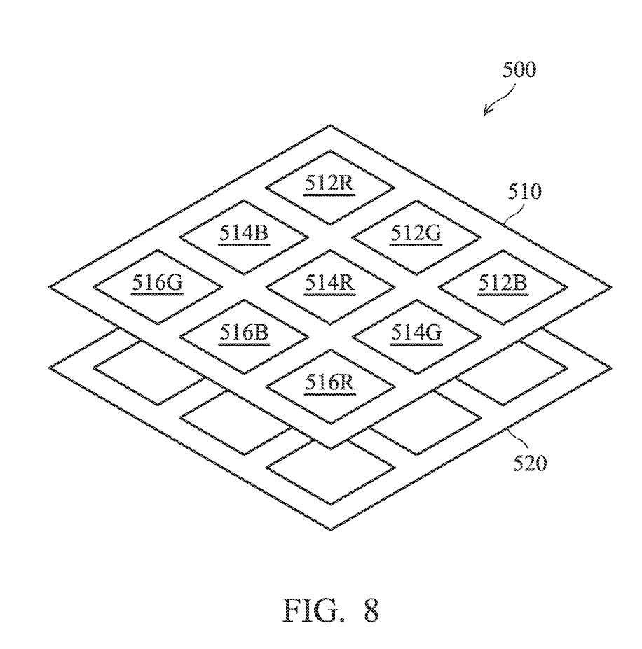

FIG. 8 shows a schematic illustrating the arrangement of a color filter 510 and the barrier cell 520 of a single pixel of an autostereoscopic display apparatus according to an embodiment of the invention, wherein the autostereoscopic display apparatus is implemented in a portable electronic product that is able to operate in a landscape mode and a portrait mode. In FIG. 8, the pixel 500 comprises three primary colors (e.g. red (R), green (G) and blue (B)). The color filter 510 comprises a 3×3 array formed by 9 sub-pixels 512R, 512G, 512B, 514R, 514G, 514B, 516R, 516G and 516B. In the embodiment, the 9 sub-pixels are arranged in the array in a mosaic pattern. In the array of the color filter 510, each row and each column has the 3 sub-pixels corresponding to the RGB primary colors, respectively. For example, the first row has the red color sub-pixel 512R, the green color sub-pixel 512G and the blue color sub-pixel 512B, and the first column has the red color sub-pixel 512R, the blue color sub-pixel 514B and the green color sub-pixel 516G. It should be noted that no sub-pixels with the same primary color are arranged in the same row and the same column. Furthermore, in response to the arrangement of the sub-pixel array of the color filter 510, the barrier cell 520 also comprises 9 barrier sub-cells, wherein the structure of each sub-cell may be the barrier cell 200 of FIG. 2A, the barrier cell 300 of FIG. 4A and the barrier cell 400 of FIG. 6A. In one embodiment, the pixel 500 may comprise four primary colors (e.g. red (R), green (G), blue (B) and white (W)), and the color filter 510 may comprise a 4×4 array formed by 16 sub-pixels. Similarly, no sub-pixels with the same primary color are arranged in the same row and the same column. Therefore, the effects on color development are similar in landscape mode and portrait mode of the portable electronic product.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An autostereoscopic display apparatus, comprising:
a liquid-crystal panel; and
a barrier cell, comprising:
a first substrate, comprising a first electrode;
a second substrate, comprising a second electrode and a third electrode, wherein the second electrode and the third electrode are separated from each other; and
a liquid-crystal layer disposed between the first substrate and the second substrate,
wherein a first black region corresponding to the overlap of the first electrode and the third electrode is formed when a first voltage is applied to the first electrode and the second electrode and a second voltage is applied to the third electrode.

2. The autostereoscopic display apparatus as claimed in claim 1, wherein the second electrode and the third electrode are overlaid by the first electrode.

3. The autostereoscopic display apparatus as claimed in claim 1, wherein a white region corresponding to the overlap of the first electrode and the second electrode is formed.

4. The autostereoscopic display apparatus as claimed in claim 1, wherein the first electrode, the second electrode, and the third electrode are formed by transparent electrodes.

5. The autostereoscopic display apparatus as claimed in claim 1, wherein a first finger part of the second electrode and a second finger part of the third electrode are mutually interlaced and separated by a slit.

6. The autostereoscopic display apparatus as claimed in claim 5, wherein the first substrate further comprises a fourth electrode, wherein the first electrode and the fourth electrode are separated from each other.

7. The autostereoscopic display apparatus as claimed in claim 6, wherein a third finger part of the first electrode and a fourth finger part of the fourth electrode are mutually interlaced.

8. The autostereoscopic display apparatus as claimed in claim 6, wherein a third finger part of the first electrode and a fourth finger part of the fourth electrode are mutually interlaced and separated by a slit.

9. The autostereoscopic display apparatus as claimed in claim 8, wherein the first black region and a second black region corresponding to the overlap of the fourth electrode and the third electrode is formed when the first voltage is applied to the first electrode, the second electrode, and the fourth electrode and the second voltage is applied to the third electrode.

10. The autostereoscopic display apparatus as claimed in claim 9, wherein a first white region and a second white region corresponding to the overlap of the fourth electrode and the second electrode is formed.

11. The autostereoscopic display apparatus as claimed in claim 9, wherein the first voltage is a grounding voltage, and the second voltage is an overdriving voltage.

12. The autostereoscopic display apparatus as claimed in claim 9, wherein the liquid-crystal layer is formed by low driving voltage liquid crystals.

13. The autostereoscopic display apparatus as claimed in claim 1, further comprising:
a first polarizer disposed above the barrier cell;
a second polarizer disposed below the barrier cell;
a first wide-view film disposed on the first polarizer; and
a second wide-view film disposed on the second polarizer.

14. The autostereoscopic display apparatus as claimed in claim 1, wherein the liquid-crystal panel comprises:
a color filter having a plurality of pixels, wherein each of the pixels has N primary colors and comprises an array formed by a plurality of sub-pixels,
wherein each row and each column of the array has the N sub-pixels corresponding to the N primary colors, and the sub-pixels have different primary colors in the same row and the same column of the array.

15. An autostereoscopic display apparatus, comprising:
a liquid-crystal panel; and
a barrier cell, comprising:
a first substrate, comprising a first electrode;
a second substrate, comprising a second electrode and a plurality of third electrodes, wherein the second electrode and the third electrodes are separated from each other, and each of the third electrodes is floating and is surrounded by the second electrode; and
a liquid-crystal layer disposed between the first substrate and the second substrate,
wherein a black region corresponding to the overlap of the first electrode and the second electrode is formed when a first voltage is applied to the first electrode and a second voltage is applied to the second electrode.

16. The autostereoscopic display apparatus as claimed in claim 15, wherein the second electrode and the third electrodes are overlaid by the first electrode.

17. The autostereoscopic display apparatus as claimed in claim 15, wherein a white region corresponding to the overlap of the first electrode and the third electrodes is formed.

18. The autostereoscopic display apparatus as claimed in claim 15, wherein the first electrode, the second electrode, and the third electrodes are formed by transparent electrodes.

19. The autostereoscopic display apparatus as claimed in claim 15, further comprising:
a first polarizer disposed above the barrier cell;
a second polarizer disposed below the barrier cell;
a first wide-view film disposed on the first polarizer; and
a second wide-view film disposed on the second polarizer.

20. The autostereoscopic display apparatus as claimed in claim 15, wherein the liquid-crystal panel comprises:
a color filter having a plurality of pixels, wherein each of the pixels has N primary colors and comprises an array formed by a plurality of sub-pixels,
wherein each row and each column of the array has the N sub-pixels corresponding to the N primary colors, and the sub-pixels have different primary colors in the same row and the same column of the array.
